(19) United States
(12) Patent Application Publication
(10) Pub. No.: US 2001/0025773 A1
(43) Pub. Date: Oct. 4, 2001

(54) Draw out arrangement for molded case circuit breakers

(76) Inventors: Mahesh Jaywant Rane, Bangalore (IN); Janakiraman Narayanan, Hosur (IN); Chandrakumar Shantaraju, Bangalore (IN); Pavan Ramachandra Vitthal Kashyap, Bangalore (IN); Anilkumar Dinker Pandit, Bangalore (IN); K. V. Sridhar, Bangalore (IN); Patrick Letient, Saint-Quentin (FR)

Correspondence Address: CANTOR COLBURN, LLP, 55 GRIFFIN ROAD SOUTH, BLOOMFIELD, CT, 06002

(21) Appl. No.: 09/681,238

(22) Filed: Mar. 2, 2001

Related U.S. Application Data
(60) Provisional application No. 60/190,299, filed on Mar. 17, 2000.

(51) Int. Cl. H01H 9/24

(52) U.S. Cl. 200/50.21

(57) ABSTRACT

A draw-out arrangement for molded case circuit breakers is disclosed. A circuit breaker plug-in system generally comprises a plug-in base to which the draw-out mechanism is secured. The base includes a right plate and a left plate. A circuit breaker is movable between the right plate and the left plate and is retractably connected to the plug-in base by the action of the draw-out mechanism. The draw-out mechanism of the present invention includes a shaft connecting the right plate to the left plate which provides rigidity to the system and balances the circuit breaker during movement. When a crank is inserted into the draw out mechanism and used to rotate a lead screw connected therein, a rider positioned about the lead screw is prevented from rotating due to being sandwiched between a pair of plates. Movement is thereby translated into linear motion which is used to move the circuit breaker into or out of engagement with the plug-in base.

### CROSS REVERENCE TO RELATED APPLICATION ross Reference To Related Applications

This application is based upon, and claims the benefit of, United States Provisional Patent Application No. 60/190,299 filed on Mar. 17, 2000, which is herein incorporated by reference in its entirety.

### BACKGROUND OF INVENTION

This invention relates to a draw-out unit for electrical switchgear cabinets.

More specifically, this invention relates to a draw-out unit for mounting a molded case circuit breaker in a switchgear cabinet.

The use of switchgears in electrical distribution systems is well known. The switchgear houses a plurality of draw-out units, with each draw-out unit housing one or more switching devices, such as motor controllers and circuit breakers, releasably interconnected to one or more busbars. Periodically, the draw-out units are removed from the switchgear to allow for maintenance of equipment. The switching devices within the draw-out units make electrical contact with the busbars through a plurality of clip connectors, which extend from the draw-out unit. Each clip connector is electrically connected to an electrical conductor for connection to the switching devices of the switchgear. As the draw-out unit is inserted into the switchgear, the busbar slides between the two contact arms, and the contact arms frictionally engage the busbar.

Two types of draw out systems are prevalent. The first type of system uses two levers, one connected on each side of a breaker, and both the levers have to be moved simultaneously. This requires use of both hand and skill for using the system. This system cannot be used when the panel (in which the breaker is enclosed) door is closed. A second type of system is operated by a crank mounted on one side of the breaker, or at the bottom portion of the breaker. This system can be operated by one hand, but has other disadvantages. The system with crank on one side uses bulky plastic components (for support to its mechanism) and makes the draw out system bulky. When the crank system is mounted at the bottom it interferes with the termination of cables, as a result of which, the cables must be terminated only at the rear. Furthermore, this second type of draw-out system cannot be added on to an existing breaker.

One such draw-out mechanism is described in U. S. Pat. No. 4,743,715 issued May 10, 1988. These mechanisms have discrete positions for testing, installing and removing the circuit breaker. The positions may be referred to as CONNECT, DISCONNECT and TEST. In the CONNECT position the circuit breaker can be closed, opened or tripped. In the DISCONNECT position the circuit breaker is in the trip position and the draw-out mechanism can be locked to prevent access to the circuit breaker. The third position is TEST, wherein the circuit breaker is disconnected from the main circuit. In the TEST position the circuit breaker can be closed, opened or tripped in order to check internal and external accessories such as auxiliary switches, shunt trip and under voltage and secondary circuits. However, draw-out mechanisms with a “test” position relate to air circuit breakers (ACB's), which are large in size. Because these draw-out mechanisms are larger in size, they also tend to be costly to produce.

### SUMMARY OF INVENTION

The above discussed and other drawbacks and deficiencies of the prior art are overcome or alleviated by a circuit breaker plug-in system. In an exemplary embodiment of the invention, the circuit breaker plug-in system has a plug-in base with a left plate and a right plate, a draw-out mechanism secured to the plug-in base and having a shaft connecting the right plate to the left plate, the draw-out mechanism further including a main unit held adjacent the right plate, and, a plug-in circuit breaker retractably connected to the plug-in base by action of the draw-out mechanism, the circuit breaker movably positioned between the left plate and the main unit.

The main unit of the draw-out mechanism further preferably comprises a slider plate adjacent the right plate of the plug-in base, a guide plate positioned parallel to the slider plate, a lead screw held between the slider plate and the guide plate, a rider threadably connected to the lead screw, a first cam plate positioned between the rider and the guide plate, and a flat plate positioned between the rider and the slider plate. The shaft passes through the first cam plate and is connected to the flat plate on a first end of the shaft. The draw-out mechanism further comprises a second cam plate positioned on a second end of the shaft. Rotation of the lead screw imparts linear motion to the rider, and linear motion of the rider imparts rotation to the first cam plate and flat plate, which in turn imparts rotation to the shaft and second cam plate.

### BRIEF DESCRIPTION OF DRAWINGS

Referring to the exemplary drawings wherein like elements are numbered alike in the several Figures:

FIG. 1 is a three dimensional perspective view of a molded case circuit breaker in a draw out mechanism;

FIG. 2 is a three dimensional perspective view of a molded case circuit breaker;

FIG. 3 is a three dimensional perspective view of a draw out mechanism for a molded case circuit breaker;

FIG. 4 is another three dimensional perspective view, from a different angle than that shown in FIG. 3, of a draw out mechanism for a molded case circuit breaker; and

FIG. 5 is a cam plate for the draw out mechanism of FIGS. 3 and 4.

### DETAILED DESCRIPTION

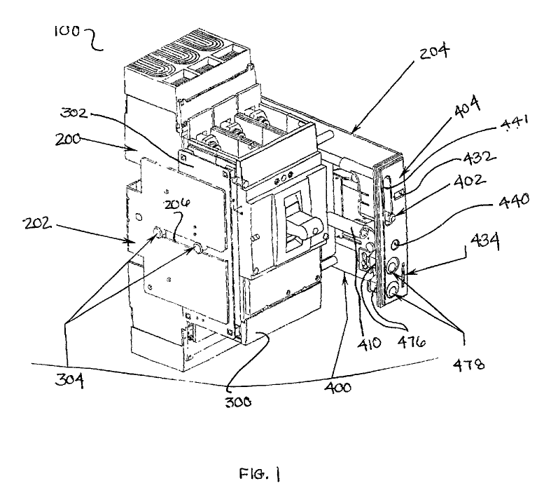

Referring to FIG. 1, a circuit breaker plug-in system is shown generally at 100. The circuit breaker plug-in system 100 generally comprises a plug-in base 200 to which a draw out mechanism 400 is secured. The draw-out mechanism 400 is connected to an electrical distribution circuit (not shown) at clip connectors which receive plug-in contacts 308 of the circuit breaker 300. A circuit breaker 300 is retractably connected to the plug-in base 200 by the action of the draw out mechanism 400.

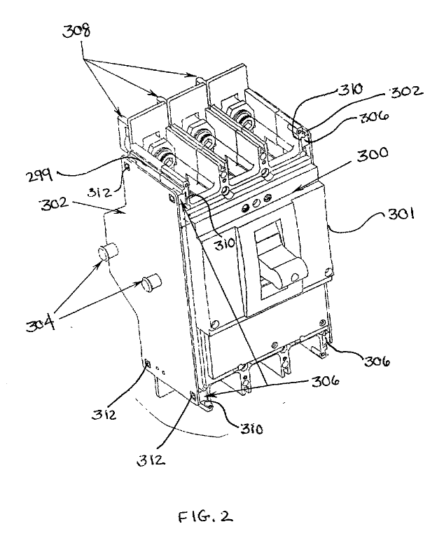

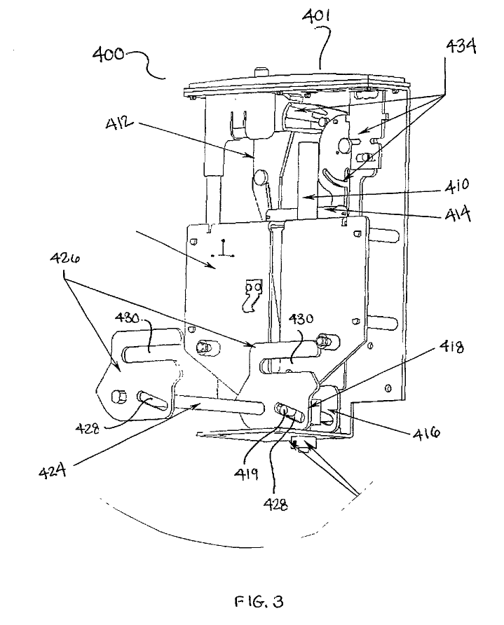

FIG. 2 shows the circuit breaker 300 disengaged from the plug-in base 200 and FIG. 3 shows the draw out mechanism 400 divorced from the plug-in base 200. The plug-in base 200 and draw out mechanism 400 form a rigid and guided draw-out system for guiding the circuit breaker 300 in and out of the circuit breaker plug-in system 100. On one side of the plug-in base 200 a left plate 202 including a guide slot 206 is secured to the plug-in base 200. On the opposite side of the plug-in base 200 a right plate 204 including a guide slot 206 is secured to the plug-in base 200. The right plate 204 holds the draw out mechanism 400 between the right plate 204 and the circuit breaker 300, while the left plate 202 is coupled to the right plate 204 through a shaft 424 (not shown in FIG. 1). The left plate 202 provides rigidity and balances the circuit breaker 300 while the circuit breaker 300 is being moved in or out of the circuit breaker plug-in system 100.

In FIG. 2 the circuit breaker 300, having a right side 301 and a left side 299, is shown to include three plug-in moveable contacts 308 which may engage with stationary contacts on the plug-in base 200 when the circuit breaker 300 is moved into engagement with the plug-in base 200. The circuit breaker 300 preferably has a plurality of shaped profiles 310 (indents) in which a plurality of wedges 306 can be slidably engaged. A pair of support plates 302 are affixed to the circuit breaker 300 on either side thereof by, for instance, a set of screws 312, inserted through the support plates 302 and fastened on the wedges 306. The support plates 302 and the wedges 306 are thus captively secured to the circuit breaker 300. The support plates 302 have a pair of riveted guide pins 304 for guiding the circuit breaker 300 onto the left plate 202 and right plate 204 along the guide slot 206.

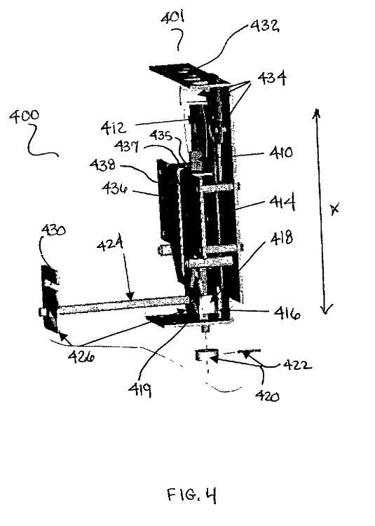

As shown in FIGS. 3 and 4, the draw out mechanism 400 includes a main unit 401 held adjacent the right plate 204. The draw out mechanism 400 comprises a lead screw 410 capable of being rotably coupled to a crank 402 (shown in FIG. 1 detached from the lead screw 410 and held in a storage slot). The lead screw 410 may include a sleeve portion (again as shown in FIG. 1) for accepting the crank 402. The crank 402 and lead screw 410 in combination extend essentially the full depth of the draw-out mechanism 400 from front to back. When the lead screw 410 is rotated by way of the crank 402 linear motion is imparted to a rider 418 threadably connected to the lead screw 410. This linear motion is directed along the screw axis, which is parallel to the axis indicated at X. The rider 418 is restricted from rotating by being held between a cam plate 426 (first cam plate) and a flat plate 416 disposed on one end of a shaft 424. The rider 418 includes a protrusion 419 which is coupled to a first slot 428 in the first cam plate 426 whereby linear motion of the rider 418 rotates the first cam plate 426 (and the flat plate 416) with a shaft 424 connected thereto. The lead screw 410 is contained in the draw out mechanism 400 by a bush 420 and split pin 422. The rotation of the cam plate 426 and shaft 424 rotates a cam plate 426 (a second cam plate) disposed on the opposite end of the shaft 424 at the opposite side of the circuit breaker 300. The shaft 424 is supported and pivoted inside holes provided on the left plate 202 and right plate 204 and is free to rotate about the axis of the shaft 424. A first slot 428 and second slot 430 in the cam plate 426 engage the rider 418 and guide pins 304 on the support plate 302. The first slot 428 and second slot 430 have a profile operative to transmit the operating force from the rider 418 to the circuit breaker 300 with high efficiency.

Continuing in FIGS. 3 and 4, the rider 418 also moves a slider plate 414 linearly which in turn rotates a position indicator 412. The position indicator 412 is operative to rotate between distinct positions. The positions, which are viewable through a view window 432 in a front cover 404 of the draw out mechanism 400, indicate the positions of the circuit breaker 300 with respect to the plug-in base 200. The positions may be identified for example, as ENGAGED, ISOLATED and WITHDRAWN. Graphics (not shown) indicative of these positions may be provided on the position indicator 412 such that only one graphic per position is visible through the view window 432 at a time.

The slider plate 414 is also guided in the right plate 204 by means of two pins riveted thereto, thereby ensuring that the motion of the slider plate 414 matches that of the rider 418. A guide plate 436 including a slot 438 fitted on the right plate 204 holds the guide pins 304 of the support plate 302 in the slotted profile of the guide plate 436. This ensures linear motion of the circuit breaker 300 proportional to that of the slider plate 414. The guide plate 436 includes a top portion 437 having a hole 435 which locates the lead screw 410 and has provision for holding the crank 402 when the crank 402 is not in use. The opposing end of the lead screw 410 is held captive to the right plate 204 with a bush 420 and split pin 422.

The slider plate 414 is also linked to a locking mechanism 434 that provides a facility to lock the circuit breaker 300 in the ISOLATED position.

The right plate 204 provides a plurality of features and is so designed that these features can be accessed through a single cutout in the panel door when the circuit breaker 300 is installed inside a panel. Thus the crank 402 may be stored and an access hole 440 is provided for insertion of the crank 402 during draw out operation.

Figure locks 476 are optional features provided as part of the draw out mechanism. Two such locks can be fitted in the holes 478 provided on the right support plate 204 and front cover 404 as shown in FIG. 1. The locks 476 are preferably fitted from inside using threads available on the body of the locks and are tightened by a nut that fits on these threads. They are operated by a key which may be inserted through holes 478.

This draw out arrangement also provides appropriate motions to the circuit breaker 300 so as to cause opening of the circuit breaker 300 through the use of a trip arrangement in between the plug-in base 200 and the circuit breaker 300. This draw out arrangement is designed to facilitate installation thereof and use on the circuit breaker 300 with the plug-in base 200 even if the plug-in base 200 and circuit breaker 300 are supplied separately.

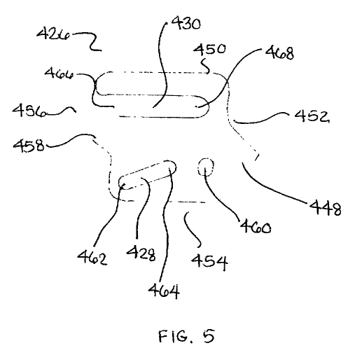

FIG. 5 depicts the cam plate 426 including the first slot 428 and the second slot 430. The cam plate 426 is preferably a flat plate 448 composed of a stamped steel component. The flat plate 448 has a periphery 458 defined by a first side 450, a second side 452, a third side 454, and a fourth side 456. The first side 450 and third side 454 are preferably generally straight and parallel to each other. The second side 452 and fourth side 456, on the other hand, include irregular peripheries including curvatures as shown. The first slot 428 is contained fully within the periphery 458 of the flat plate 448. The first slot 428 includes a first end 462 located near an intersection of the third side 454 and fourth side 456. The second end 464 of the first slot 428 is further from the third side 454 than the first end 462 is to the third side 454. The second slot 430 includes a first end 466 which is open on the fourth side 456 and a second end 468 which is adjacent the second side 452. The cam plate 426 further includes an aperture 460 sized for receiving the shaft 424. The aperture 460 is preferably adjacent an intersection of the second side 452 and the third side 454. The cam plate 426 further preferably includes rounded corners in its periphery 458 and the first slot 428, second slot 430, and aperture 460 further preferably include rounded ends.

The plug-in base 200 and the draw-out mechanism 400 can be supplied as accessories. A customer already in possession of a circuit breaker can use these accessories, i.e. plug-in base 200 and draw-out mechanism 400, to convert the breaker from a fixed type to a withdrawable type. This could be done by first fitting the support plates 302 on the breaker (e.g. breaker 300). Then, the draw-out mechanism 400 could be assembled on the plug-in base 200 and the breaker 300 fitted onto the draw-out mechanism 400 by sliding the guide pins 304 into the slots of the accessories, e.g. slots 206 in left plate 202 and right plate 204 attached to plug-in base 200 and slots 430 in draw-out mechanism 400.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments failings within the scope of the appended claims.

1. A cam plate for use in a draw-out mechanism, the draw-out mechanism for moving a plug-in circuit breaker with respect to a plug-in base, the cam plate comprising:
a flat plate having a first side, second side, third side, and fourth side, the flat plate having a periphery;
an aperture within the flat plate sized for receiving a shaft, the aperture adjacent an intersection of the second and third sides;
a first slot positioned fully within the periphery of the flat plate, the first slot having a first end adjacent an intersection of the third and fourth sides; and,
a second slot having a first end open on the fourth side, the second slot having a second end adjacent the second side.

2. The cam plate of claim 1 wherein the flat plate is a stamped steel component.

3. The cam plate of claim 1 wherein the periphery includes rounded corners.

4. The cam plate of claim 1 wherein ends of the first slot are rounded, the second end of the second slot is rounded, and the aperture is rounded.

5. The cam plate of claim 1 wherein the first end of the first slot is closer to the third side than a second end of the first slot.

6. The cam plate of claim 1 wherein the first and third sides are parallel to each other and the second and fourth sides each include curved portions.

7. A draw-out mechanism for moving a plug-in circuit breaker with respect to a plug-in base, the draw-out mechanism comprising:
a slider plate;
a guide plate positioned parallel to the slider plate;
a lead screw held between the slider plate and the guide plate;
a rider threadably connected to the lead screw;
a first cam plate positioned between the rider and the guide plate;
a flat plate positioned between the rider and the slider plate;
a shaft passing through the first cam plate and connected to the flat plate on
a first end of the shaft; and,
a second cam plate positioned on a second end of the shaft;
wherein rotation of the lead screw imparts linear motion to the rider, and linear motion of the rider imparts rotation to the first cam plate and flat plate, which in turn imparts rotation to the shaft and second cam plate.

8. The draw-out mechanism of claim 7 wherein the first cam plate includes an aperture for passing the shaft and a first slot for receiving a protrusion from the rider.

9. The draw-out mechanism of claim 7 wherein the guide plate includes a top portion having a hole for locating the lead screw.

10. The draw-out mechanism of claim 7 further comprising a crank rotatably coupled to the lead screw.

11. The draw-out mechanism of claim 7 wherein the lead screw is contained in the draw-out mechanism by a bush and split pin.

12. The draw-out mechanism of claim 7 further comprising a position indicator located on the slider plate, wherein linear motion of the rider imparts linear motion to the slider plate, and wherein linear motion of the slider plate rotates the position indicator.

13. The draw-out mechanism of claim 12 wherein the slider plate is attached to a front cover having a window, the window providing a view of the position indicator.

14. The draw-out mechanism of claim 7 wherein the guide plate includes a slot parallel with a screw axis of the lead screw.

15. The draw-out mechanism of claim 10 wherein the slider plate is attached to a front cover having an access hole for insertion of the crank.

16. A circuit breaker plug-in system comprising:
a plug-in base having a left plate and a right plate;
a draw-out mechanism secured to the plug-in base and having a shaft connecting the right plate to the left plate, the draw-out mechanism further including a main unit held adjacent the right plate; and,
a plug-in circuit breaker retractably connected to the plug-in base by action of the draw-out mechanism, the circuit breaker movably positioned between the left plate and the main unit.

17. The circuit breaker plug-in system of claim 16 wherein a guide slot is provided on the left plate, a guide pin extending from a left side of the circuit breaker is captured within the guide slot on the left plate.

18. The circuit breaker plug-in system of claim 17 further comprising a right support plate attached to the right side of the circuit breaker and a left support plate attached to the left side of the circuit breaker, wherein the right support plate and left support plate include guide pins.

19. The circuit breaker plug-in system of claim 18 wherein the right support plate and the left support plate are attached to the circuit breaker by screws.

20. The circuit breaker plug-in system of claim 16 wherein the main unit of the draw-out mechanism further comprises:
a slider plate adjacent the right plate of the plug-in base;
a guide plate positioned parallel to the slider plate;
a lead screw held between the slider plate and the guide plate;
a rider threadably connected to the lead screw;
a first cam plate positioned between the rider and the guide plate; and
a flat plate positioned between the rider and the slider plate;
wherein the shaft passes through the first cam plate and is connected to the flat plate on a first end of the shaft;
the draw-out mechanism further comprising a second cam plate positioned on a second end of the shaft;
wherein rotation of the lead screw imparts linear motion to the rider, and linear motion of the rider imparts rotation to the first cam plate and flat plate, which in turn imparts rotation to the shaft and second cam plate.

21. The circuit breaker plug-in system of claim 20 wherein the left plate and the right plate of the plug-in base include holes for rotatably receiving the shaft.

22. The circuit breaker plug-in system of claim 20 wherein the first cam plate includes a first slot for receiving a protrusion from the rider and a second slot for receiving a first guide pin from the right support plate.

23. The circuit breaker plug-in system of claim 22 wherein the guide plate includes a slot for receiving a second guide pin from the right support plate.

24. The circuit breaker plug-in system of claim 23 wherein the second cam plate includes a slot for receiving a guide pin from the left support plate.

25. The circuit breaker plug-in system of claim 20 wherein the slider plate includes pins protruding towards and guided within the right plate.

26. The circuit breaker plug-in system of claim 20 further comprising a locking mechanism to lock the circuit breaker in an isolated position.

27. The circuit breaker plug-in system of claim 20 wherein the guide plate includes a top portion having a hole for locating the lead screw.

28. The circuit breaker plug-in system of claim 20 further comprising a crank rotatably coupled to the lead screw.

29. The circuit breaker plug-in system of claim 20 wherein the lead screw is contained in the draw-out mechanism by a bush and split pin.

30. The circuit breaker plug-in system of claim 20 further comprising a position indicator located on the slider plate, wherein linear motion of the rider imparts linear motion to the slider plate, and wherein linear motion of the slider plate rotates the position indicator.

31. The circuit breaker plug-in system of claim 30 wherein the slider plate is attached to a front cover having a window, the window providing a view of the position indicator.
